(19) United States
(12) Patent Application Publication
(10) Pub. No.: US 2016/0147594 A1
(43) Pub. Date: May 26, 2016

(54) METHOD AND APPARATUS FOR PREVENTING AND MANAGING CORRUPTION OF FLASH MEMORY CONTENTS

(71) Applicant: QUALCOMM TECHNOLOGIES INTERNATIONAL, LTD., Cambridge (GB)

(72) Inventors: Gary WALKER, Phoenix, AZ (US); Nikhil BHATIA, Gilbert, AZ (US); David CAVANAUGH, Tempe, AZ (US); Tom RICKS, Tempe, AZ (US)

(21) Appl. No.: 14/554,325

(22) Filed: Nov. 26, 2014

(51) Int. Cl. G06F 11/10

(52) U.S. Cl. CPC G06F 11/1004; G06F 11/1048

(57) ABSTRACT

The present invention relates to methods and apparatuses for eliminating or mitigating the effects of the corruption of contents in a flash memory, such as that which can occur during a power interruption. Embodiments of the invention include methods for preventing the corruption of code stored in flash memory. Such methods can include partitioning code in separate physical blocks as data in a flash memory. Embodiments of the invention also include methods for mitigating the effects of corruption of data stored in flash memory. Such methods can include a book-keeping mechanism that allows for the detection of corruption events, along with the affected locations in flash memory.

### FIELD OF THE INVENTION

The present invention relates to managing computer memory contents, and more particularly to a method and apparatus for preventing corruption of code and allowing for recovery when data corruption occurs in a flash memory.

### BACKGROUND OF THE INVENTION

Flash memory is used in a variety of computer applications. For parallel types of flash memory, the signal interface between a computer processor and an external flash memory is controlled as specified by the external flash manufacturer. Some manufactures provide mechanisms via this interface to prevent or help recover from the effects of corruption of flash memory contents, such as that which can occur when the power supply to the computer processor and/or flash memory is interrupted. However, serial types of flash memory have become more popular and do not typically include such mechanisms. Accordingly, there exists a need to address this problem, among others.

### SUMMARY OF THE INVENTION

The present invention relates to methods and apparatuses for eliminating or mitigating the effects of the corruption of contents in a flash memory, such as that which can occur during a power interruption. Embodiments of the invention include methods for preventing the corruption of code stored in flash memory. Such methods can include partitioning code in separate physical blocks as data in a flash memory. Embodiments of the invention also include methods for mitigating the effects of corruption of data stored in flash memory. Such methods can include a book-keeping mechanism that allows for the detection of corruption events, along with the affected locations in flash memory.

In accordance with these and other aspects, a method of preventing corruption of code in a flash memory device according to embodiments of the invention includes identifying physical blocks of the flash memory device, storing code in a partition of one or more of the identified physical blocks, and preventing data from being programmed and erased in the partition.

In further accordance with these and other aspects, a method of managing corruption of data in a flash memory device according to embodiments of the invention includes maintaining a book-keeping structure in non-volatile memory separate from the flash memory device, identifying a portion of the flash memory device in which an erase or program operation is to be commenced, and setting a field in the book-keeping structure that includes the identified portion and indicates that an erase or program operation is being performed, such that if a corruption event occurs during the erase or program operation, a possible corruption of the identified portion of the flash memory can be determined from the book-keeping structure.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example device in which embodiments of the invention can be implemented;

FIG. 2 is a block diagram further illustrating an example device in which embodiments of the invention can be implemented;

FIG. 3 is a functional block diagram illustrating example approaches for managing corruption of flash memory contents according to embodiments of the invention;

FIG. 4 is a diagram illustrating an example method of partitioning a flash memory according to embodiments of the invention; and

FIG. 5 is a flowchart illustrating example aspects of managing flash memory program operations according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The present invention provides techniques to prevent code corruption and mitigating effects of data corruption in an external serial flash memory coupled to a computer processor. According to certain aspects, the computer processor is configured to boot from ROM and to validate code in external flash memory by performing a CRC check. According to further aspects, code corruption prevention includes partitioning code and data in separate physical blocks of a flash memory to prevent code corruption due to sudden loss of power during data erase or programs. According to still further aspects, by limiting each data program or erase operation to a single sector, an on-chip flash manager limits the potential damage due to sudden loss of power to one sector. According to yet further aspects, a book-keeping mechanism helps in detecting data corruption events and possible recovery without impacting the device performance.

Embodiments of the invention will be described in connection with a useful application in global satellite positioning systems. However, the invention is not limited to this application, and those skilled in the art will understand how to implement the invention in other types of systems after being taught by the present examples.

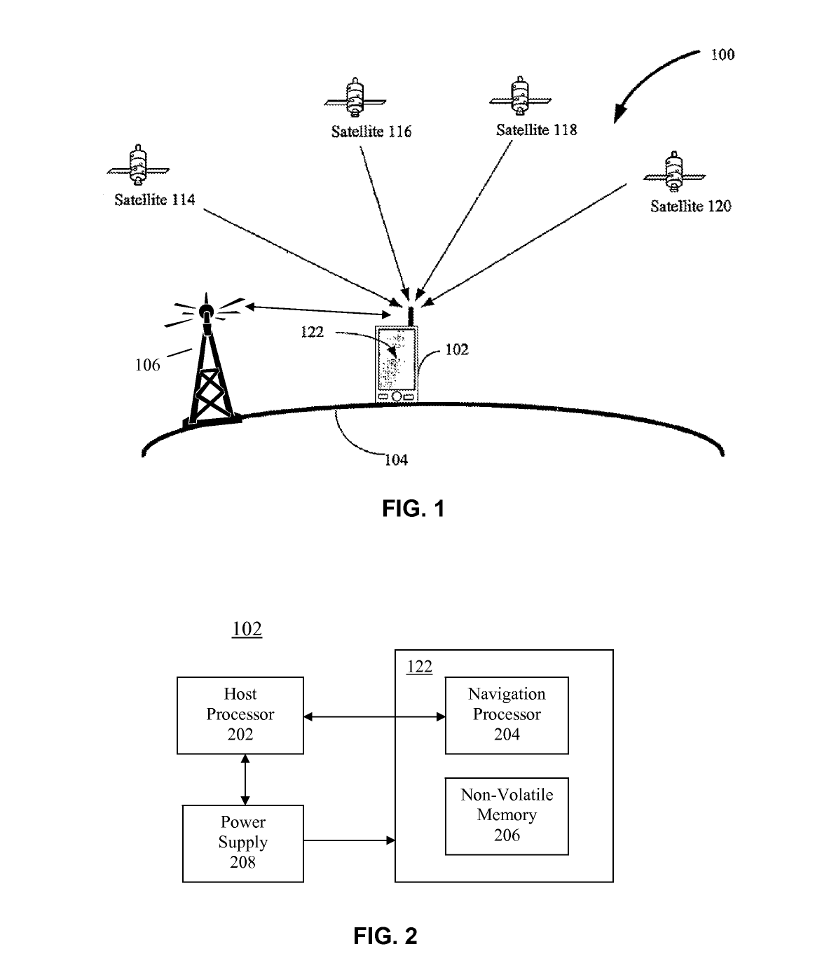

FIG. 1 illustrates an example implementation of embodiments of the invention. As shown in FIG. 1, an example system 100 includes GNSS satellites (i.e. satellite vehicles or SVs) 114, 116, 118 and 120 that broadcast signals that are received by GNSS module 122 in device 102, which is located at a user position somewhere relatively near the surface of earth 104. The term Global Navigation Satellite System (GNSS) is used as the standard generic term for satellite navigation systems (“sat nav”) that provide autonomous geo-spatial positioning with global coverage. Examples of GNSS systems include the Global Positioning System (“GPS”), GLONASS, Galileo and BDS. GNSS module 122 can be configured to use signals from satellites of only a single one of these systems, or it can be configured to use signals from satellites of two or more of these systems.

Device 102 can be a cellular or other type of telephone with built-in GPS functionality (e.g. iPhone, Galaxy or other Android smartphone, etc.), or it can be a notebook or tablet computer (e.g. iPad, Galaxy Note, Surface, etc.) with similar built-in positioning functionality, or it can be a personal navigation device (PND, e.g. from Garmin, TomTom, etc.) or a tracking device (e.g. automotive tracking from Trimble, package or fleet management tracking from FedEx, child locator tracking applications etc), or an automobile navigation/media system, or a watch (e.g. Nike sport watch), etc.

GNSS module 122 can be implemented using any combination of hardware and/or software, including chipsets such as SiRFstar V from CSR Technology, as adapted and/or supplemented with functionality in accordance with the present invention, and described in more detail herein. More particularly, those skilled in the art will be able to understand how to implement the present invention by adapting and/or supplementing such chipsets and/or software with the code and data corruption improvement techniques of the present invention after being taught by the present specification.

In operation, using signals from at least four SVs 114, 116, 118, 120, receiver 122 provides a 3-dimensional navigation solution (only three satellites are required for a 2-dimensional navigation solution, e.g. by using known height), for example by performing trilateration techniques and using PVT filters and algorithms known to those skilled in the art. This solution can be also be based on, or supplemented by, inertial signals such as those from accelerometers. The navigation solution from receiver 122 can be used by device 102 in a variety of ways, depending on the type of device. As shown, device 102 can also include hardware/software functionality for communicating with a network 106 (e.g. telephone, WiFi, Internet, etc.).

FIG. 2 is a block diagram illustrating an example device 102 according to embodiments of the invention. As shown, device 102 includes a host processor 202 (e.g. CPU and associated software/firmware) that communicates with a navigation processor 204 in GNSS module 122 using a defined interface (e.g. UART, I2C, SPI, etc. in example embodiments where GNSS module 122 is implemented by a SiRFstar V). Processor 204 further communicates with its own dedicated non-volatile memory 206 (e.g. flash memory). It should be apparent that device 102 can include many additional components such as memories, displays, network interfaces, etc. Likewise GNSS module 122 can include many additional components such as antennas, RF signal processors, accelerometers, etc. However, these additional components are not illustrated for the sake of clarity of the invention.

In typical operation, when desired by host processor 202, navigation processor 204 provides a GNSS-derived navigation solution (e.g. location and time) to host processor 202 at defined intervals such as one report every one second. In embodiments, host processor 202 can also provide initial software (i.e. code) setups or updates to navigation processor 204, which navigation processor 204 stores in non-volatile memory 206 when provided.

As further shown in FIG. 2, device 102 further includes a power supply 208 that is controlled by host processor 202. In embodiments, both code and data for navigation processor 204 is stored in non-volatile memory 206. However, since host processor 202 controls the power supply 208, it can remove power to navigation processor 204 and non-volatile memory 206 at any time (e.g. in response to power on/off switch on device 102, etc.). If power is removed while the memory 206 is performing an erase or program of either code or data, corruption can occur.

More particularly, in one example embodiment, non-volatile memory 206 is a serial flash memory. The present inventors have discovered that, due to the physical architecture of the serial flash memory device, other data within the same physical block being erased or programmed can be corrupted. Data within a physical block share bit lines. When a specific bit is not completely erased or programmed, the value read from other bits within that physical block can either be incorrect or inconsistent. If the corrupted data is fully erased, the value read from the other bits within the physical block will now be correct. The physical block sizes vary based on the manufacturer and serial flash memory size. Physical block sizes include 4 KB, 64 KB, 128 KB, 256 KB and 512 KB.

According to certain aspects, the present invention eliminates the risk of code corruption and detects data corruption due to such events. According to further aspects, if there is a possibility of data corruption, an attempt is made to restore the data. Example embodiments in furtherance of these and other aspects will be described herein below.

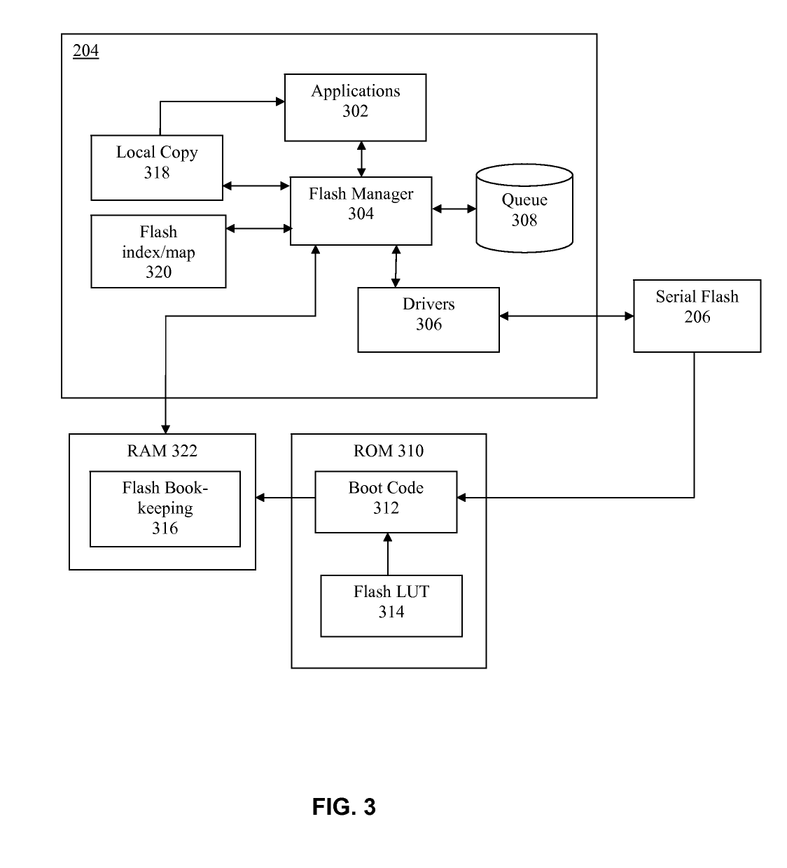

FIG. 3 is a functional block diagram illustrating an example approach to managing corruption of data and code in a GNSS module 122 such as that shown in FIG. 2 according to embodiments of the invention.

As shown in the example of FIG. 3, further coupled to processor 204 is a read-only memory (ROM) 310 that includes boot code 312 and a flash lookup table (LUT) 314. On power-up or other initiation of module 112, processor 204 is configured to execute boot code 312 from ROM 310. As part of this boot code 312, processor 204 interacts with external serial flash memory 206 to determine its manufacturer, using signals well known to those skilled in the art. A flash lookup table (LUT) 314 is also stored in ROM 310 to determine the configuration for storing code and data for the detected serial flash memory. Based on the manufacturer, the configuration is identified and stored in flash memory map/index 320. As shown in the example embodiment of FIG. 3, this memory map/index 320 is dynamically generated and stored in volatile memory of processor 204.

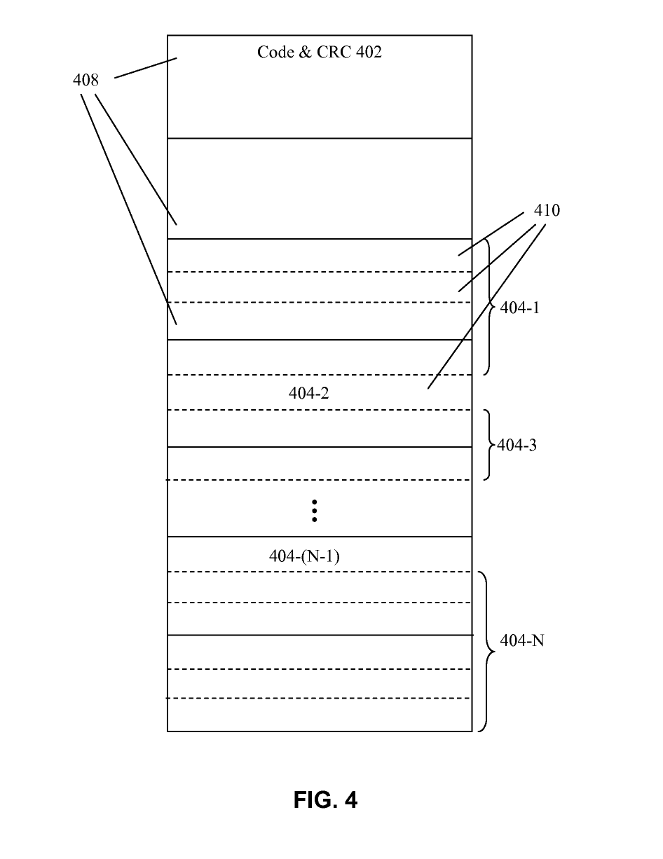

FIG. 4 illustrates an example configuration of memory 206 according to embodiments of the invention. As shown, and according to aspects of the invention, to prevent code in the external serial flash memory 206 from being corrupted due to sudden loss of power during data program or erase, code is located in separate physical blocks from data. This prevents code from being corrupted by partially programmed or erased data. More particularly, as shown in this example, memory 206 includes a code partition 402 and a plurality of data partitions 404-1 to 404-N. Each data partition 404 corresponds to a single data type, as will be described in more detail below. It should be noted, however, that it is not necessary in all embodiments for there to be separate partitions 404 for different data types.

As shown in FIG. 4, according to aspects of the invention, partition 402 is in a separate one or more physical blocks 408 from the physical blocks 408 occupied by the data partitions 404. As further shown, each block 408 is comprised of one or more sectors 410. Data partitions 404 can occupy one or more sectors 410. In the example of FIG. 4, data partitions 404 can span across different blocks 408, and two or more data partitions 404 can occupy the same physical block 408.

In some embodiments, the particular configuration of memory 206, including block size and the particular locations and sizes of partitions 402, 404 for each flash manufacturer is pre-determined and stored in LUT 314. In other embodiments, only the physical block size is stored in LUT 314, and the locations and/or sizes of some or all of partitions 402, 404 are determined dynamically based on the physical block size, the amount of code, and the number of sizes of data types. In any event, once the partitions are determined, information regarding them is stored in flash map/index 320 for subsequent use by FM 304 for reading and writing data from and to data partitions 404.

It should be noted that although partitions 402 and 404 are illustrated as occupying contiguous physical blocks, this is not necessary in all embodiments. The only requirement is that code partition 402 is in separate physical block(s) 408 from block(s) 408 occupied by data partitions 404.

As further shown in FIG. 4, and to be described in more detail below, along with code, a CRC value is stored in partition 402. Similarly, one or more CRC values are stored for every data partition 404 as will be described in more detail below.

Returning to FIG. 3, in addition to determining the configuration of memory 206, boot code 312 includes verifying that the code already stored in memory 206 is valid. In embodiments, this includes performing a cyclic redundancy check (CRC) on the code stored in partition 402 and comparing the determined CRC value (e.g. a 32-bit value or CRC32) with the CRC value stored together with the code in partition 402. It should be noted that other validation techniques other than CRC can be used, such as checksum, length checks, etc.

It should be further noted that boot code 312 can also include functionality for causing code in flash memory 206 to be initially loaded or updated, for example by host processor 202. In these and other embodiments, boot code 312 can include functionality for communicating with host processor 202 to receive the code, write the code to partition 402 of memory 206, and calculate a CRC. In embodiments, as part of a code update, host processor 202 is required to provide power to processor 204 while code is being loaded into flash memory 206 to prevent it from being corrupted.

Upon successful verification that the code stored in memory 206 is valid, boot code 312 configures processor 204 for regular operation. In the illustrated example of processor 204, this includes initiating applications 302 (e.g. GNSS navigation applications that process satellite data to obtain navigation solutions), flash manager (FM) 304, and drivers 306. Generally, and as will be described in more detail below, flash manager 304 handles all accesses to flash memory 206 requested by applications 302 and using drivers 306. Meanwhile, the particular implementation details of applications 302 and drivers 306 are not necessary for an understanding of the present invention, and so they will be omitted here for the sake of clarity of the invention. The code for causing processor 204 to execute applications 302, FM 304 and drivers 306 can be stored in one or both of memory 206 and ROM 310, and boot code 312 can load some or all of this code in volatile program memory in processor 204, as will be appreciated by those skilled in the art.

Requests from applications 302 to access data in flash memory 206 are placed in a queue 308 by FM 304. In embodiments, these requests are executed by FM 304 using information in flash map/index 320 at the end of each processing cycle if there is enough time left for execution. This ensures that performance of high priority tasks is not impacted by flash access operations. For example, applications 302 can be executed in threads, with certain operations that are scheduled to be completed every cycle (e.g. processing to produce a navigation solution once every second). In these and other embodiments, FM 304 executes at a lower priority than these operations, and only during the remaining time of each processing cycle.

In embodiments to be described in more detail below, FM 304 causes all requested erase or program accesses to flash memory 206 to be protected from corruption by storing key details into book-keeping structure 316 prior to the start of the operation using a book-keeping mechanism. In embodiments shown in FIG. 3, structure 316 is kept in non-volatile RAM 322 coupled to processor 204.

Serial flash memory book-keeping structure 316 also includes a CRC32 which is used to determine if the book-keeping information is valid. The following shows an example of data structure 316 according to embodiments of the invention.

| | | | |
|---|---|---|---|
| CRC32 | Program/Erase | P/E | Data Type |
| (32 bits) | Sector # | bit | Bit Mask |
| | (11 bits) | | (20 bits) |

In this example, the P/E bit is set to 1 immediately before processor 204 begins programming or erasing a sector, and is set to 0 after the program or erase has been completed. The P/E Sector is the sector that is currently being programmed or erased. This is valid only if the P/E bit is set to 1. The data type bit mask includes one bit for every data type. Each bit has a value of 0 if the corresponding data element is good, and is set to 1 if the corresponding data element needs to be erased before writing.

The following Table lists one non-limiting example of the bits in the data type bit mask, along with the corresponding data type. This example is in connection with an embodiment of the invention where applications 302 perform GNSS positioning programs, and the data stored in flash memory includes almanac, ephemeris, extended ephemeris, etc. for a plurality of GNSS satellites, as well as for several different GNSS systems including GPS, GLONASS, etc.

TABLE 1

Bit 0: UTC Data
Bit 1: XO Data
Bit 2: GPS Almanac
Bit 3: GLO Almanac
Bit 4: BDS Almanac
Bit 5: Galileo Almanac
Bit 6: GPS EE Header
Bit 7: GLO EE Header
Bit 8: GPS CGEE
Bit 9: GLO CGEE
Bit 10: GPS SGEE
Bit 11: GLO SGEE
Bit 12: User Data Type 1
Bit 13: Data Log
Bit 14: RTC Learning Data
Bit 15: User Data Type 3
Bit 16: User Data Type 4
Bit 17 to Bit 19: Reserved for future use

In embodiments to be described in more detail below, FM 304 ensures that all data stored in flash memory 206 are stored in terms of data records. All serial flash memory manufacturers define a sector to be 4 KB, and so embodiments of FM 304 define data records in terms of flash memory sectors. Given that sectors are typically the same size or smaller than physical block sizes, a sector will only contain data for one data element type. In embodiments, FM 304 causes drivers 306 to erase data in partitions 404 of the flash memory 206 using the serial flash memory sector erase command. All serial flash memory manufacturers also support a page program command where 1 to 256 bytes are written, and in embodiments FM 304 causes drivers 306 to perform all program operations using a page program command.

Before an erase or program begins, FM 304 updates structure 316 to indicate that an erase or program is in progress (P/E bit). In addition, FM 304 also stores the corresponding sector number being erased or programmed in structure 316. After drivers 306 complete the erase or program operation, FM 304 updates structure 316 indicating that an erase or program is no longer in progress.

If a power loss occurs and then power is reapplied to GNSS module 122, boot code 312 will configure processor 204 as described above, and initiate FM 304. When first initiated, FM 304 will perform a CRC on the bits in the structure 316 to see whether it is valid by comparing the determined CRC to the stored CRC. If so, and if the P/E bit indicates an erase or program was in progress, then FM 304 causes the sector identified in structure 316 to be erased. This will prevent a partially erased or programmed sector from corrupting other sectors within the same physical block. If FM 304 determines that the serial flash memory book-keeping information in structure 316 is not valid based on the CRC32 comparison, then FM 304 updates the book-keeping structure 316 to indicate that all data elements stored in serial flash memory need to be erased.

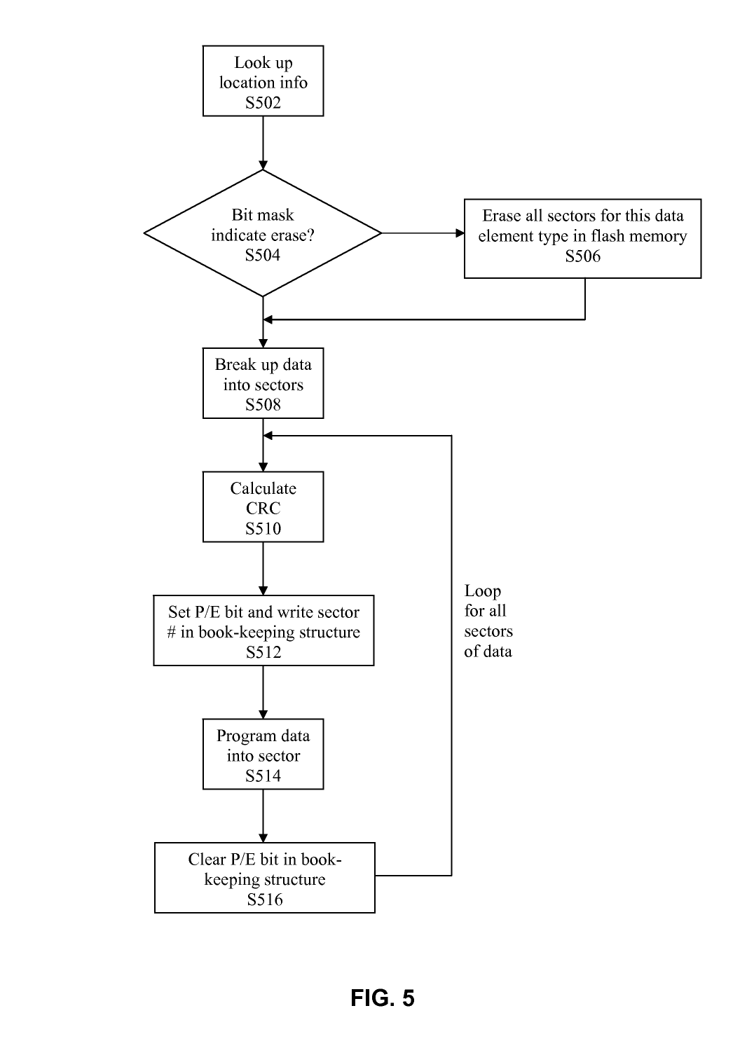

Example aspects of how FM 304 performs a program operation based on requests from applications 302 will now be described in more detail in connection with the flowchart in FIG. 5.

When applications 302 request a data element to be written to flash memory 206, in step S502 FM 304 first looks up information regarding the designated location for the data element type in flash memory map/index 320. In embodiments, this information includes the identification of one or a plurality of sectors 410 in flash memory 206 corresponding to the data element type. In these and other embodiments, this information also includes the sector(s) where the next or newest copy of data for this data element type should be stored. For example, FM 304 and flash memory map/index 320 can implement a circular buffer for multiple copies of the same data element type, wherein the newest copies of the data element type overwrite the oldest copies stored in flash memory 206. This can be done, for example, for wear leveling reasons, so that erases and programs are more evenly distributed among sectors 410. It should be noted that multiple copies may not be stored for all data element types. For example, there may be only one most recent copy of a given data element type stored in flash memory 206.

Next in step S504, FM 304 checks the bit in data type bit mask of the book-keeping structure 316 corresponding to the data element to determine whether the data element needs to be erased. If an erase is indicated by the bit mask, processing branches to step S506 where, for one sector at a time, and for all sectors associated with the data element (and possibly also including all copies thereof), FM 304 updates structure 316 to indicate that the sector is being erased, instructs drivers 306 to erase that sector, and then updates structure 316 when the erase operation has completed.

Next in step S508, FM 304 breaks the data to be written into sectors. For each sector amount of data (e.g. 4 kB), in step S510 FM 304 calculates a CRC32 for that data. Next in step S512 FM 304 updates the book-keeping information 316 to indicate that the sector is being programmed. In step S514 FM 304 causes drivers 306 to store the data and CRC32 together in the designated sector in memory 206. Then in step S516 FM 304 updates the book-keeping information 316 to clear the P/E bit.

Example aspects of processing performed by FM 304 when applications request data to be read from flash memory 206 will now be described.

As mentioned above, there may be several copies (i.e. data records) of a data element type in memory 206. So, in this case, first FM 304 uses information in flash index 320 to determine the sector(s) containing the data element type. In embodiments, along with each copy, a time tag is stored. Using this time tag information, FM 304 identifies the most up-to-date data record of the data element type. For each sector of data, FM 304 causes drivers 306 to read the data record from serial flash memory 206 and writes the data record to local copy 318. FM 304 then performs a CRC and validates it with the CRC32 stored along with the record. The data record is only used if it is valid.

If the data record is valid, only the local copy 318 is thereafter used by applications 302 because the data read from serial flash memory 206 may be inconsistent. If FM 304 determines the newest data record(s) read from flash memory 306 is not valid, the above steps are repeated with the next oldest data record. The local copy 318 is still used regardless of whether the book-keeping structure 316 indicates the data element needs to be erased. This allows valid data records in serial flash memory 206 to be used when power was removed from non-volatile memory (normally, a rare event). As mentioned above, when power is applied the very first time, FM 304 marks all data elements as invalid.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method of preventing corruption of code in a flash memory device, comprising:
identifying physical blocks of the flash memory device;
storing code in a partition of one or more of the identified physical blocks; and
preventing data from being programmed and erased in the partition.

2. A method according to claim 1, further comprising preventing power being removed from the flash memory device while the step of storing code is being performed.

3. A method according to claim 1, wherein the step of storing code includes computing a cyclic redundancy check (CRC) for the code and storing the CRC along with the code in the partition.

4. A method according to claim 1, wherein identifying the physical blocks includes:
identifying a manufacturer of the flash memory device; and
determining a size of the physical blocks based on the identified manufacturer.

5. A method according to claim 4, further comprising determining the partition based on the determined size of the physical blocks and a size of the code.

6. A method according to claim 5, wherein preventing includes computing a flash memory map that includes the partition and separate partitions for data for use in subsequent data erase and programming operations.

7. A method according to claim 6, wherein computing includes determining separate partitions for one or more data element types.

8. A method according to claim 1, wherein the flash memory device is a serial flash memory device.

9. A method according to claim 1, wherein the code is for performing global navigation satellite system (GNSS) positioning applications, and wherein the flash memory device is externally coupled to a processor for performing the GNSS positioning applications.

10. A method of managing corruption of data in a flash memory device, comprising:
maintaining a book-keeping structure in non-volatile memory separate from the flash memory device;
identifying a portion of the flash memory device in which an erase or program operation is to be commenced; and
setting a field in the book-keeping structure that includes the identified portion and indicates that an erase or program operation is being performed,
such that if a corruption event occurs during the erase or program operation, a possible corruption of the identified portion of the flash memory can be determined from the book-keeping structure.

11. A method according to claim 10, further comprising clearing the field in the book-keeping structure after the erase or program operation has completed.

12. A method according to claim 10, wherein the identified portion is a specific sector of the flash memory device.

13. A method according to claim 10, further comprising:
receiving a request for programming data to the flash memory device;
splitting the data into two or more records corresponding a sector size of the flash memory device; and
performing a separate program operation to the flash memory device for each of the two or more records,
wherein the identifying and setting steps are performed before each of the separate program operations.

14. A method according to claim 10, further comprising:
identifying a manufacturer of the flash memory device;
determining locations and sizes in the flash memory device for each of a plurality of different data types based on the identified manufacturer;
storing the locations and sizes in a flash memory map,
wherein identifying the portion of the flash memory device is performed using the flash memory map.

15. A method according to claim 14, further comprising:
maintaining a bit mask for each of the plurality of different data types in the book-keeping structure; and
determining whether to erase contents of the flash memory device associated with one of the plurality of different data types based on a bit corresponding to the one data type in the bit mask.

16. A method according to claim 14, wherein the plurality of different data types are associated with global navigation satellite system (GNSS) positioning applications, and wherein the flash memory device is externally coupled to a processor for performing the GNSS positioning applications.

17. A method according to claim 10, wherein the flash memory device is a serial flash memory device.
